(19) United States
(12) Patent Application Publication
(10) Pub. No.: US 2020/0043081 A1
(43) Pub. Date: Feb. 6, 2020

(54) SYSTEM AND METHOD FOR ORDERING AND RECEIVING DIGITAL GOODS THROUGH TEXT MESSAGING

(71) Applicant: LAZLO 326, LLC, Jacksonville, FL (US)

(72) Inventor: Michael C. Pinkus, Duluth, GA (US)

(21) Appl. No.: 16/530,186

(22) Filed: Aug. 2, 2019

Related U.S. Application Data
(60) Provisional application No. 62/713,764, filed on Aug. 2, 2018.

(51) Int. Cl. G06Q 30/06; G06Q 20/12

(52) U.S. Cl. CPC G06Q 30/0635; G06Q 20/123

(57) ABSTRACT

There is shown a system for ordering and receiving digital goods through a text messaging mobile computer device having a conventional scanning device. The computer device includes conventional text messaging software and a display screen. The computer device also includes conventional wireless transmission capabilities which are capable of wireless communication. The system also have a device or terminal with a display screen or panel which displays a product catalog of goods for purchase and digital delivery of claim information. The device requests a unique per transaction code provided by the shopping system server for each individual consumer session.

### CROSS REFERENCE TO RELATED APPLICATIONS

Applicant claims the benefit of U.S. Provisional Patent Application Ser. No. 62/713,764 filed Aug. 2, 2018 and entitled “SYSTEM AND METHOD FOR ORDERING AND RECEIVING DIGITAL GOODS THROUGH TEXT MESSAGING”.

### TECHNICAL FIELD

This invention relates generally to a system of ordering digital goods on a computer system through text messaging.

### BACKGROUND OF THE INVENTION

Ordering merchandise through a global internet provider has existed for many years. Also, digital goods purchased at physical stores is hard because you need to join a digital persona to a physical device in a store so that both digital and physical cart/items can be paid for at the same time in the same shopping basket. Existing methods require complex integration between phone and device such as Bluetooth or other wireless protocols.

It thus is seen that a need has long existed for a system and method of ordering goods through text messaging which enables a person to so without complex integration. Accordingly, it is to the provision of such that this invention is primarily directed.

### BRIEF DESCRIPTION OF THE DRAWINGS

FIG. 1 is a schematic view showing representing the screen shot of a computer device utilizing the system of the present invention.

FIG. 2 is a schematic view of a coded image of the system of the present invention.

FIG. 3 is a schematic view showing the text messaging screen shot of the computer device utilizing the system of the present invention.

FIG. 4 is a schematic view showing the text messaging system of the present invention.

### DETAILED DESCRIPTION

With reference next to the drawings, there is shown a system for ordering and receiving digital goods 10 through a text messaging mobile computer device 12 having a conventional scanning device 13, such as a camera and related software. The computer device 12 includes conventional text messaging software and a display screen 14. The computer device also includes conventional wireless transmission capabilities which are capable of wireless communication.

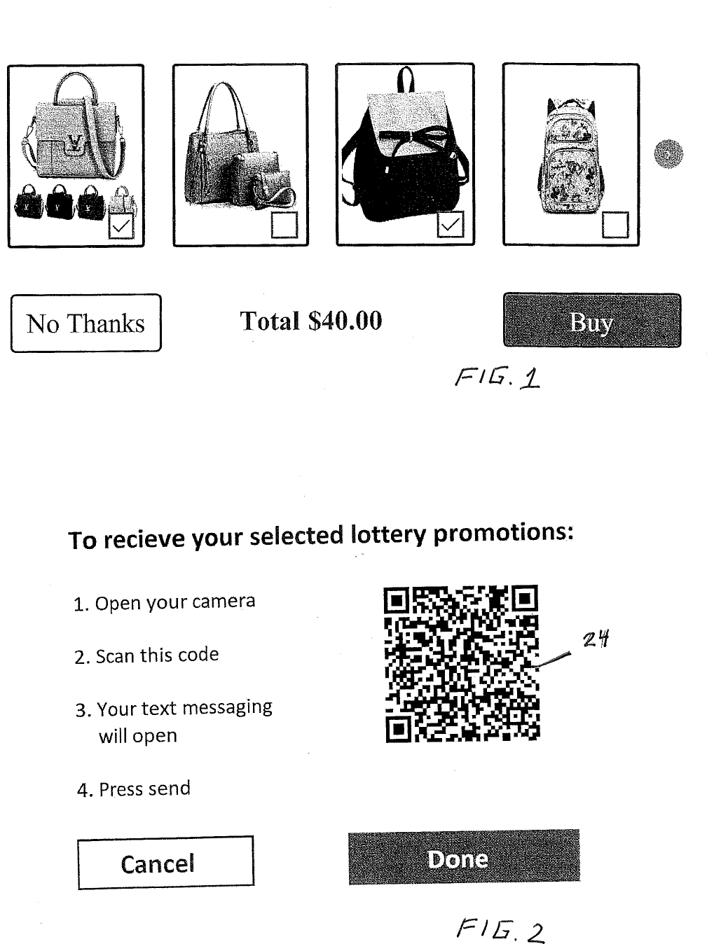

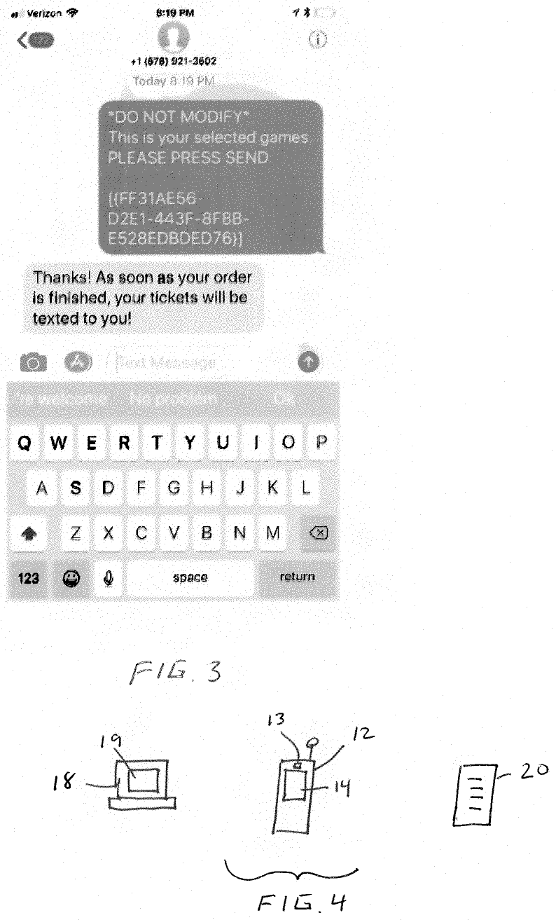

The consumer presents at a device or terminal 18 such as a payment terminal or kiosk or other. The device 18 has a display screen or panel 19 which displays a product catalog of goods for purchase and digital delivery of claim information, as shown by FIG. 1.

The device 18 requests a unique per transaction code provided by the shopping system server 20 for each individual consumer session.

The consumer selects desired goods or products from the product catalog and creates a virtual cart on the device for this individual consumer session.

Once all goods are selected, the consumer chooses to checkout and add cart to line items of amounts due to be paid for by the consumer.

The device 18 adds the unique identifiers of the selected product items into a list and the unique per transaction code to a data schema.

The device 18 then encodes the data schema into a machine readable code such as qrcode or barcode, as shown in FIG. 2.

The device 18 then displays of the display panel 19 of the device 18 the visual code 24 to the consumer with instructions to scan it using the consumers smartphone or other computer device 12.

The consumer scans this code with a smartphone scanning device 13 and text messaging app (application) or other app capable of scanning codes.

The text messaging app or other app within the smartphone, such as the camera app, can natively distinguish encoding schemes and send the data schema as a text message to a pre-encoded address such as a phone number or other text messaging account, such as a social media messenger account.

The text message is routed by the text messaging service and other 3^{rd} parties to the shopping system and received by the shopping system software. This type of communication is often referred to as a bot or chat bot.

The shopping system then creates a checkout transaction using the encoded data to identify the device that originated the transaction and the goods or products selected by the consumer.

The shopping system can determine the smartphone's/mobile computer device 12 unique address that texted the data schema.

With the device unique identifier and the consumer smartphone unique address the shopping system can create the digital goods and wait for the device to conclude the transaction after payment is confirmed.

The device can confirm the consumer smartphone has initiated the transaction by calling the shopping system with its device unique identifier.

The device can request the final price and line items to show on the device and/or pos and/or printed receipt by calling the shopping system with its device unique identifier.

The device can indicate payment has been received by calling the shopping system with its device unique identifier.

The shopping system, upon being notified by the device that payment has been received can then cause the digital goods or links or instructions to the digital goods to be texted to the consumer smartphone unique address using the same consumer smartphone unique address as the originating transaction.

The consumer can then be in possession of the digital goods or links or instructions to the digital goods in the form of a sales confirmation.

It thus is seen that a system for ordering and receiving digital goods is now provided which can be implemented through a text messaging system. Although the new lottery game and ticket has been shown in its preferred form, many modifications, additions and deletions, in addition to those expressly recited herein, may be made thereto without departure from the spirit and scope of the invention as set forth in the following claims.

1. A system for ordering and receiving digital goods comprises,
a sales terminal having a display screen and software for displaying a machine readable code upon said display screen, said sales terminal having software for producing a device unique identifier;
a mobile computer device having a scanner and software for reading said machine readable code upon said display screen, the mobile computer device also having wireless communication means and text messaging software for wirelessly transmitting and receiving messages, and
a shopping server in wireless communication with said mobile computer device, said showing server having software for processing messages sent from said mobile computer device to verify the a device unique identifier and payment and sending a sales confirmation to the mobile computer device.

2. A method for ordering and receiving digital goods comprises the steps of,
(A) providing a sales terminal having a display screen and software for displaying a machine readable code upon said display screen, said sales terminal having software for producing a device unique identifier;
(B) providing a mobile computer device having a scanner and software for reading said machine readable code upon said display screen, the mobile computer device also having wireless communication means and text messaging software for wirelessly transmitting and receiving messages;
(C) providing a shopping server in wireless communication with said mobile computer device, said showing server having software for processing messages sent from said mobile computer device to verify the a device unique identifier and payment and sending a sales confirmation to the mobile computer device,
(D) selecting goods from a selection of goods displayed upon the sales terminal;
(E) producing a device unique identifier and a machine readable code associated with the device unique identifier;
(F) scanning the machine readable code with the mobile computer device;
(G) transmitting a text message from the mobile computer device to the shopping servicer, and
(H) verifying payment with the shopping servicer and sending a text to the mobile computer device using the unique address.
